(19) United States
(12) Patent Application Publication
(10) Pub. No.: US 2009/0090297 A1
(43) Pub. Date: Apr. 9, 2009

(54) Air brush

(75) Inventor: Katsuaki Kitajima, Saku-shi (JP)

Correspondence Address: BACON & THOMAS, PLLC, 625 SLATERS LANE, FOURTH FLOOR, ALEXANDRIA, VA, 22314-1176, US

(73) Assignee: B.B.RICH CO., LTD., Saku-shi (JP)

(21) Appl. No.: 12/153,293

(22) Filed: May 16, 2008

(30) Foreign Application Priority Data
Oct. 4, 2007 (JP) 2007-261000

(51) Int. Cl. B05B 7/24

(52) U.S. Cl. 118/300

(57) ABSTRACT

To provide an air brush that can maintain a stable spray without a clog of a nozzle for discharging a coating material. In the air brush for atomizing and spraying the coating material by the compressed air inducted into the main body of the air brush, an air valve that is mounted in an air induction part provided on the main body of the air brush is opened by pushing of an operational button and an adjusting device for adjusting a discharge amount of the coating material is provided on a position deviated from an axis line of the nozzle in a passage of the coating material communicated with the nozzle.

### BACKGROUND OF THE INVENTION

1. Field of the Invention

The present invention relates to an air brush that atomizes and sprays a coating material (a pigment and a color material) just after being outputted from a nozzle with a compressed air.

2. Description of the Related Art

This kind of air brush injects a compressed air inducted into a main body of an air brush from a gap between a nozzle attached at a front end of the main body of the air brush and an air cap and derives a coating material from a coating material container that is communicated and arranged in a passage communicated with the nozzle with a suction force generated on a nozzle portion due to injection of the compressed air so as to atomize and spray the coating material just after outputted from the nozzle with the compressed air.

Then, a discharge amount of the coating material to be derived due to the compressed air that is injected from an outer periphery of the nozzle is adjusted by back and forth movement of a needle that is inserted through an axial core of the nozzle so as to be capable of moving back and forth. Back movement of the needle (opening of the nozzle) is carried out by the operation of a push button and an operational lever and the needle is normally biased in a direction to close the opening of the nozzle by an elastic force of a spring.

In addition, according to the structure to induct the compressed air to be injected from the gap between the nozzle and the air cap, by arranging an air valve in an air induction part that is attached to the main body of the air brush and operating the air brush by means of a push button and an operational lever that are mounted on the main body of the air brush, an induction port of the compressed air is opened and the compressed air is injected from the outer periphery of the nozzle (for example, refer to Japanese Patent Application Laid-open No. 2004-57839).

However, according to a conventional airbrush, the amount of opening of the nozzle is adjusted depending on back movement of the needle that is inserted in the nozzle as described above, and thereby, the discharge amount of the coating material is adjusted. Accordingly, when the coating material adhering to the front end of the needle is dried, the gap between the inner face of the nozzle and the outer peripheral face of the front end of the needle is narrowed as compared to the gap in a normal case, so that a normal spray cannot be maintained. Then, in the worst case, there is a problem such that the front end portion of the nozzle gets clocked and spray cannot be completely carried out.

Therefore, for example, in the case of temporarily stopping using of the air brush, operation the push button and the operational lever and only injecting the compressed air, and thereby, blasting off the coating material adhering to the front end of the nozzle, the coating material is prevented from being dried as adhering to the front end and getting hard. In addition, after using the air brush, throwing away the coating material and rubbing it with water or a solvent, the coating material is prevented from being left on the air cap, the nozzle, and the needle or the like. Further, it is necessary to treat the needle with the greatest care on cleaning since the front end of the needle is very narrow.

Upon spraying, the needle is made into a resistance since the needle is located inside of the nozzle, so that this involves a problem such that flowing of the coating material is prevented.

### SUMMARY OF THE INVENTION

The invention will be better understood on reading the following description given merely by way of example and with reference to the accompanying drawings, and an object of which is to provide an air brush that can maintain stable spray of a coating material since a nozzle for discharging the coating material does not get clogged.

Further other object is to provide an air brush that the coating material smoothly and stably flows toward a front end of the nozzle.

In order to attain the above-described object, the air brush according to the present invention has no needle in the inside of a nozzle through which a coating material flows, so that the present air brush can adjust the discharge amount of the coating material on a place other than the nozzle part.

Specifically, in the air brush for deriving a coating material that is communicated and arranged on a passage to be communicated with a nozzle from the nozzle and atomizing and spraying the coating material by a compressed air at the outside of the nozzle by guiding the compressed air inducted into the main body of the air brush into the inside of the main body of the air brush and injecting the compressed air from a gap between the nozzle attached at a front end of the main body of the air brush and an air cap, an air valve that is mounted in an air induction part provided on the main body of the air brush is opened by pushing of an operational button and an adjusting device for adjusting a discharge amount of the coating material is provided on a position deviated from an axis line of the nozzle in a passage of the coating material communicated with the nozzle.

The position deviated from the axis line of the nozzle where the adjusting device for adjusting the discharge amount of the coating material is arranged means a passage intersecting a passage in an axial direction to be communicated with the nozzle, and an intersectional direction may be any direction if it is in a radiation direction centering on the passage on the axis line of the nozzle.

In addition, the air valve to be mounted in the air induction part of the main body of the air brush is brought into contact with a valve sheet by a pressure due to an elastic force of a spring unless the operational button is pushed, so that flowing of the compressed air is stopped. Then, the operational button is pushed and opened against the elastic force of the spring, and the compressed air is inducted. However, the air valve is configured so that the compressed air is not inducted at a stroke. In this structure, for example, the shape of the axial part above an O ring adhering to the valve sheet is not a stepped shape that an outer diameter is made smaller at a stroke but is a taper shape that the outer diameter is gently changed. Thereby, the compressed air can be smoothly supplied.

In addition, according to the adjusting device for adjusting the discharge amount of the coating material, for example, a taper-shaped valve sheet is formed on a front end of a finger grip of a screw rotating system and the valve sheet moves backward and forward due to rotation of the finger grip, so that the opening amount of the passage of the coating material in which the valve sheet is fitted can be adjusted. Then, the inner diameter of the passage of which opening amount is adjusted by the operation of this adjusting device is about five times larger than the inner diameter (for example, 0.3 mm) of the front end of the nozzle, so that, even if the same phenomenon is caused as the case that the coating material adheres to the front end of a needle in the conventional structure such that the needle is inserted and arranged along the axis line of the nozzle, there is no problem such that the spraying state of the coating material is made unstable or the like.

A configuration of supplying the coating material to the passage to be communicated with the nozzle may be any of a suctioning system for suctioning the coating material by a suction force generated in the opening of the nozzle by injecting the compressed air from the cap between the outer periphery of the nozzle and the air cap, which has been generally employed today, and a weight system for falling the coating material by a weight of the coating material itself. Then, in the case of the suctioning system, the coating material container is vertically arranged on the lower position from the axis line of the nozzle and in the case of the weight system, any of an upper cap for arranging the coating material container above the axis line of the nozzle or a side cap for arranging the coating material container on the side position for the axis line of the nozzle or the like may be available.

In addition, a connection attaching system of the coating material container for the main body of the air brush may be any of a screwing system and a taper insertion system.

Then, in accordance with a supplying system of the coating material, the attaching position of the adjusting device can be arranged on an appropriate position on the outer periphery face of the main body of the air brush that is formed in a cylindrical shape. For example, in the case of the suctioning system, the adjusting device is arranged on the upper face side of the main body of the air brush on the opposite side of the coating material container, in the case of the upper cap of the weight system, the adjusting device is arranged on the lower face side of the main body of the air brush, and in the case of the side cap of the weight system, the adjusting device is arranged on the lateral face side of the main body of the air brush on the opposite side of the side where the coating material container is arranged.

According to the air brush of the present invention, solving a defect such that the coating material adhering to the front end of the needle is dried and the front end of the nozzle gets clogged, which is a problem in the conventional air brush, since there is no needle in the inside of the nozzle where the coating material is spraised, it is possible to maintain a stably spraying state for a long time. In addition, there is no needle (a resistance) in the inside of the nozzle, so that a smooth flow of the coating material is obtained and a stable spraying state can be established and maintained.

Further, by adjusting the opening amount by means of the operation of the adjusting device, the discharge amount of the coating material can be adjusted, so that it is possible to provide an air brush that can realize from a narrow line to a spray in a wide range.

Further, a gentle taper shape giving a resistance to a flow of the compressed air is formed in the air valve for regulating induction of the compressed air into the main body of the air brush, so that a follow of the compressed air is minute and a stable spraying state can be maintained.

### BRIEF DESCRIPTION OF THE DRAWINGS

FIG. 1 is a longitudinal sectional view showing an embodiment of an air brush according to the present invention.

FIG. 2 is a sectional view enlarging a substantial part.

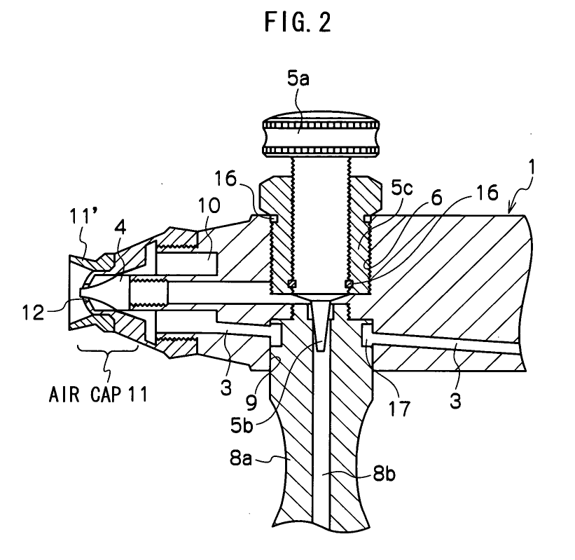

FIG. 3 shows an air valve that is mounted in an air induction part, and FIG. 3A shows an air valve used for the present invention and FIG. 3B shows a conventional air valve.

FIG. 4 shows a test pattern showing a state of spray that the air valve according to the present invention and the conventional air valve are mounted, and FIG. 4A is a test pattern of the present invention and FIG. 4B is a test pattern of the conventional air valve.

FIG. 5 is a sectional view of a substantial part showing other state that a coating material container is attached for the main body of the air brush (a weight cap type).

FIG. 6 shows other state that a coating material container is attached for the main body of the air brush (a side cap type), and FIG. 6A is a longitudinal sectional view and FIG. 6B is an enlarged sectional view along an X-X′ line of FIG. 6A.

### DESCRIPTION OF THE PREFERRED EMBODIMENTS

Hereinafter, embodiment(s) of an air brush according to the present invention will be described with reference to the drawings.

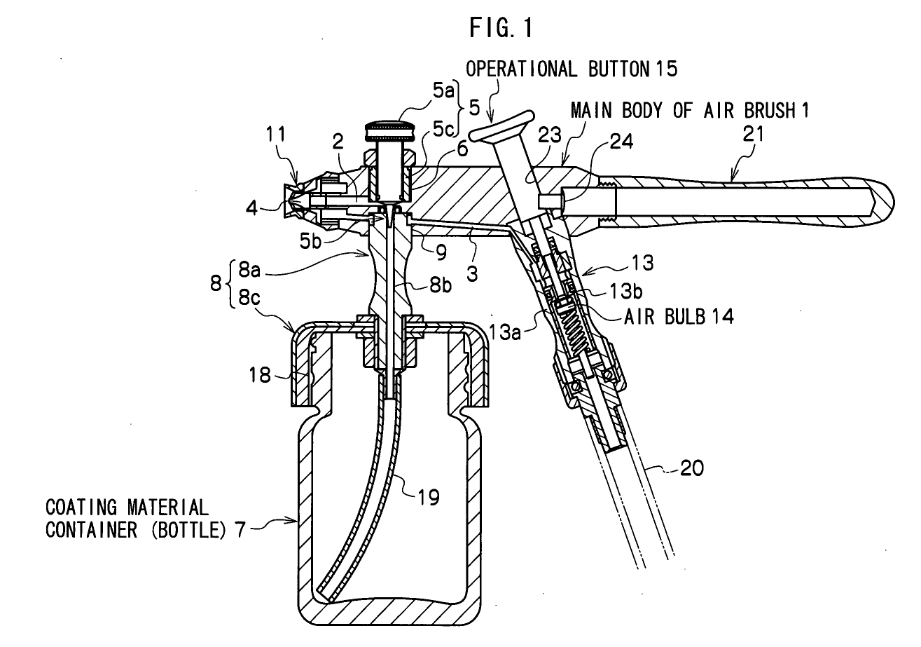

FIG. 1 shows an entire air brush of a lift-type, in which a coating container is vertically attached below the main body of the air brush. In the drawing, a reference numeral 1 denotes the main body of the air brush formed in a pen holder shape. From a center of the front end portion of this main body of the air brush 1 toward a rear part, a coating material passage 2 with a predetermined depth is opened and an air passage 3 is opened from the front end toward the rear part inside of a lower half part of the main body of the air brush 1 separated from the coating material passage 2. Then, a nozzle 4 is connected to the front end of the coating material passage 2, and an attachment hole 6 of an adjusting device 5 is opened on the upper side of the rear end part of the coating material passage 2 intersecting the coating material passage 2 substantially perpendicularly and an attachment hole 9 for attaching a holding tool 8 that vertically holds a coating material container 7 on the lower side of the coating material passage 2 with respective axial cores coinciding with each other.

In addition, at the front end of the main body of the air brush 1 where the front end of the air passage 3 is opened, an annular passage 10 is formed so as to surround the nozzle 4 being communicated with the air passage 3, a front opening portion of the annular passage 10 is closed, and an air cap 11 having a passage hole 12, through which the front end of the nozzle 4 penetrates to be projected, opened is screwed and attached to the front portion of the main body of the air brush 1. Further, a nozzle cover 11′ for protecting the front end of the nozzle 4 projected from the air cap 11 is attached to the air cap 11, however, as shown in the drawing, this nozzle cover 11′ is configured separately from the air cap 11 so as to be capable of being attached and detached with a screw structure or the nozzle cover 11′ may be configured so as to be integrated with the air cap 11.

On the other hand, at the rear end in the axial direction of the main body of the air brush 1, a support shaft 21 with a predetermined length is connected toward an axial rear part. By mounting this support shaft 21 between a first finger and a root of an index finger when using the present air brush, the present air brush can be stably held by hands.

On the lower face of the rear part of the main body of the air brush 1 on which the rear part of the air passage 3 is opened, an air induction part 13 having an air valve 14 incorporated is connected and attached, and on an axis line of the air valve 14 of the air induction part 13, an operational button attachment hole 23 is opened from the upper face side of the main body of the air brush 1 toward the lower face side, and an operational button 15 for pushing the air valve 14 is attached in the operational button attachment hole 23 so as to be moving vertically and horizontally.

In addition, the release end (the rear end side) of the air induction part 13 is connected to a supply source of the compressed air (for example, an air compressor and an air cylinder or the like) (illustration is herein omitted) via a hose 20 or the like. Thereby, the air valve 14 incorporated in the air induction part 13 is pushed down by pushing movement of the operational button 15 so as to open a valve, so that the compressed is introduced from the air induction part 13 into the air passage 3 in the main body of the air brush 1. Further, the operational button 15 is defined by a locking screw 24 so as to be rotated in a peripheral direction for the main body of the air brush 1 or not to be get out upward, and the operational button 15 can be detached from the main body of the air brush 1 by unfixing the support shaft 21 to unfix the locking screw 24.

In the air induction part 13, a valve sheet tube 13b is screwed and mounted in the inside of a connection tube 13a and through a shaft core of the valve sheet tube 13b, the air valve 14 is inserted so as to be capable of being swung.

The air valve 14 has a valve body 14b integrally on a substantially middle position in a length direction of a valve pestle 14a, a coil spring 14c is mounted by an elastic pressure on an outer periphery of the valve pestle 14a on the lower face side of the valve body 14b, and on the upper face side of the valve body 14b, an O ring 14d securing tight coherence with a valve sheet of the valve sheet tube 13b is mounted on the upper face side of the valve body 14b. Further, on the valve pestle 14a located above the O ring 14d, a gentle taper part 14e is integrally formed, of which diameter on the side of the O ring 14d is larger and is made smaller step by step as it is separated from the O ring.

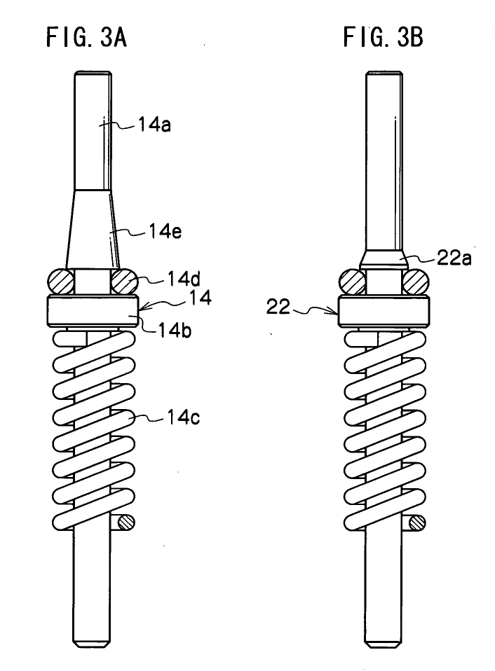

Then, the length of this taper part 14e is formed so as to be substantially five times of the length in the axial direction of a taper part 22a formed in a conventional air valve 22 (refer to FIG. 3B) having the same figuration. Further, the air valve 14 according to the present invention has the same entire size and the same appearance as the conventional air valve 22 and only the length of the taper part 14e is different from the conventional air valve 22.

The adjusting device 5 is configured by a finger grip 5a of a screw rotating system provided with a valve pestle 5b formed in a taper shape at the front end and a holding tube 5c screwing and holding the finger grip 5a rotatably. Then, the holding tube 5c is fitted and fixed to the attachment hole 6 opened on the main body of the air brush 1. Further, on the outer peripheral face of the lower part of the finger grip 5a and the outer peripheral face of the upper part of the holding tube 5c, a seal material 16 such as an O ring is mounted in order to secure airtightness between the corresponding holding tube and the corresponding main body of the air brush, respectively.

The valve pestle 5b is formed in a taper shape so as to be narrowed step by step toward the front end side, an outlet of a communication passage to be described later is opened by moving upward due to the rotation of the finger grip 5a, and the opening amount can be adjusted so as to be increased and decreased.

In addition, on the attachment hole 9 opened on the lower face side of the main body of the air brush 1 coaxially with the axis line of the attachment hole 6 of the adjusting device 5, the holding tool 8 for vertically holding the coating material container 7 is fitted and fixed.

The holding tool 8 is configured by an axial member 8a on which a communication passage 8b to be communicated with the coating material passage 2 is opened and a cover member 8c that is fixed on one side portion of the axial member 8a. Then, on the outer periphery of the side portion to be fitted to the attachment hole 6 of the axial member 8a, an annular groove 17 is formed. When the axial member 8a is fitted and fixed on the attachment hole 6, the annular groove 17 intersects the air passage 3, the air passage 3 is not divided by the axial member 8a, and a communication state is maintained by the annular groove 17.

In addition, the side of the outlet opened on the coating material passage 2 in the communication passage 8b opened on the axial member 8a is formed in a taper hole so as to adhere tightly to the valve pestle 5b of the finger grip 5a. Thereby, rotating the finger grip 5a of the adjustment device 5 and lifting it, the valve pestle 5b of the finger grip 5a is pulled out from the communication passage 8b and the outlet of the communication passage 8b is opened, so that the communication passage 8b is communicated with the coating material passage 2. Then, by rotating the finger grip 5a and adjusting the upward moving amount of the valve pestle 5b, the opening amount of the outlet of the communication passage 8b can be adjusted, and thereby, the discharge amount of the coating material can be adjusted so as to be increased and decreased.

The cover member 8c to be fixed to the axial member 8a is fitted to other side part of the axial member 8a and is fixed being sandwiched by a nut or the like. Then, the cover member 8c is configured in such a manner that a screw member 18 molded by a synthetic resin is integrally fitted on the inside and the coating material container 7 is attached by screwing.

In addition, a tube 19 is coupled to the end portion of the axial-member 8a project into the inside of the cover member 8C so as to be capable of sanctioning the coating material contained in the coating material container 7 and transporting it to the communication passage 8b. Further, the connection structure of the cover member 8c and the coating material container 7 is not limited to a screw system but other system may be available.

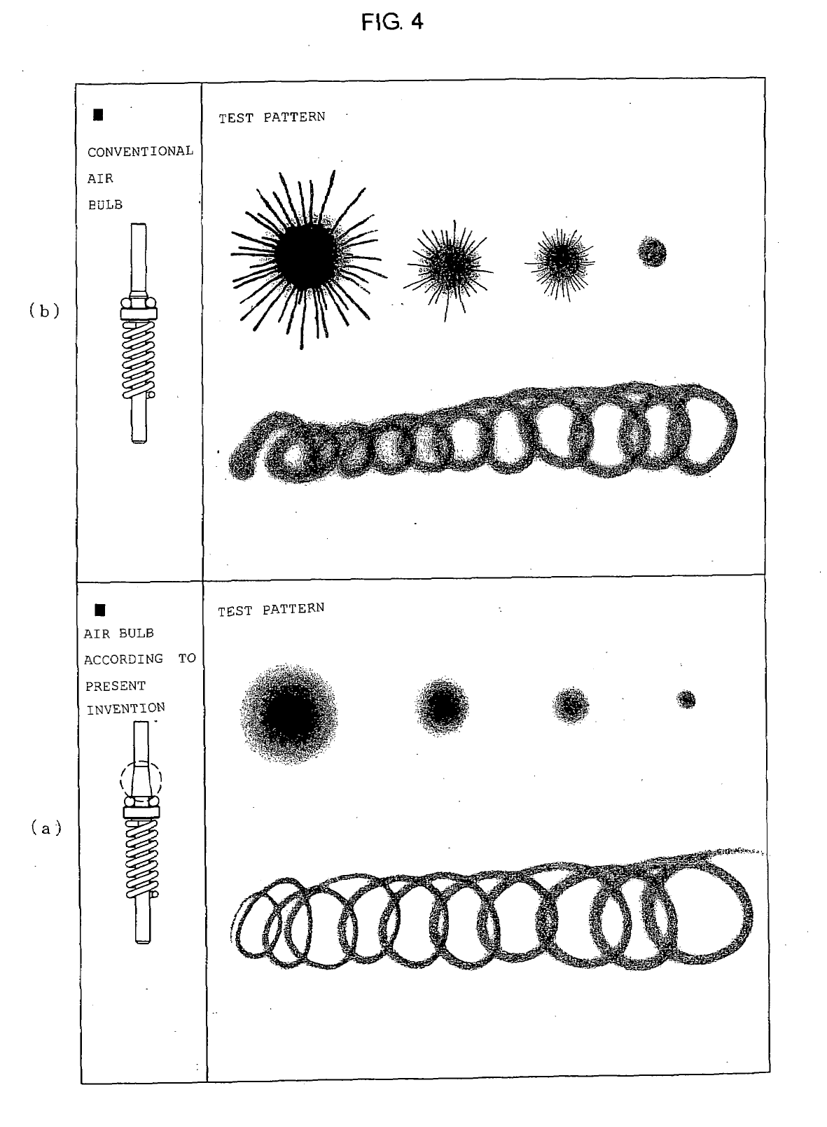

An atomizing state is tested by mounting the air brush configured as described above and the conventional air valve 22 (refer to FIG. 3B) in the air induction part 13 of the present airbrush. The results are as shown in a test pattern of FIG. 4. Further, the structure of the conventional air valve 22 shown in FIG. 3B used for the test has the same structure as the air valve 14 (refer to FIG. 3A) according to the present invention other than a point that a ratio of length between the taper parts 22a and 14e formed above the O ring is substantially 1:5.

According to the air brush on which the conventional air valve 22 is mounted, no resistance (the needle) is located in the inside of the nozzle 4 upon spraying, so that the coating material flows speedily to be discharged from the nozzle 4. In other words, when the coating material is discharged at a stroke, as shown in the test pattern of FIG. 4B, a splash phenomenon of the coating material is caused. This splash phenomenon is caused when the coating material left in the coating material passage 2 is sanctioned and discharged at a stroke because the needle is not inserted through the nozzle and the compressed air is supplied at a stroke due to a descending movement of the air valve being pushed by the operational button 15 to be injected at a stroke from the outer periphery of the nozzle 4.

On the contrary, according to the present air brush, the air valve 14 mounted on the air induction part 13 has the taper part 14a (a gentle taper shape) with a length substantially five times of the length of a taper part 22a of the conventional air valve 22 as described above, so that, even when the operational button 15 is pushed, the opening amount due to a descending movement of the air valve 14 is smaller than the conventional structure, and a resistance functions against the flow of the compressed air. Thereby, the compressed air is not supplied at a stroke but is smoothly supplied being cumulated and spray of the compressed air from the outer periphery of the nozzle 4 is made very narrow. As a result, even if the coating material is left in the inside of the coating material passage 2, as shown in the test pattern of FIG. 4A, a splash phenomenon of the coating material is solved since spray of the compressed air is very narrow.

Further, by rotating the finger grip 5a of the adjusting device 5 that is arranged to the main body of the air brush 1, the communication passage 8b is closed due to shift of the valve pestle 5b integrally formed on the lower part of this finger grip and the opening amount is adjusted due to rising of the valve pestle 5b because of rotation of the finger grip 5a. As a result, by adjusting the discharge amount of the coating material so as to be increased and decreased due to rotation of the finger grip 5a, a narrow line and spraying can be realized.

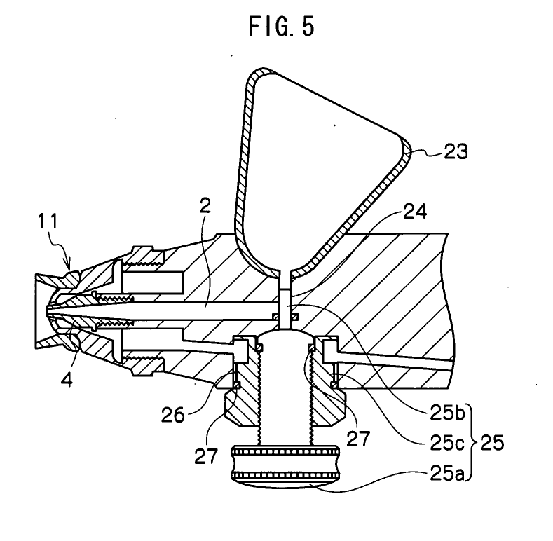

FIG. 5 is an enlarged sectional view showing the adjusting device 25 for adjusting the discharge amount of the coating material in a weight cap type that the coating material container is arranged above the axis line of the nozzle. Other structures are the same as the above-described embodiment (a suction type), so that the same members are given the same reference numerals and marks and the description thereof is herein omitted.

The coating material container 23 that is formed in a substantially conical shape is fitted and fixed in a concave portion formed on the upper face side of the main body of the air brush 1 being communicated with the communication passage 24 that intersects the coating material passage 2 of the main body of the air brush 1 at a substantially right angle. Then, on the opposite side of the attachment face of the coating material container 23, an adjusting device 25 for adjusting the discharge amount of the coating material is attached.

As same as the adjusting device 5 according to the above-described embodiment, the adjusting device 25 is configured by a screw rotation type of a finger grip 25a provided with a valve pestle 25b of a taper shape at its front end and a holding tube 25c for rotably screwing and holding the finger grip 25a. Then, the holding tube 25c is fitted and fixed on an adjusting hole 26 opened on the main body of the air brush 1. Further, on the outer peripheral face of the upper part of the finger grip 25a and the holding tube 25c and the outer peripheral face of the lower part of the adjusting hole 26, a seal material 27 such as an O ring is mounted in order to secure airtightness with the main body of the air brush 1.

The valve pestle 25b is formed in a taper shape coinciding with the taper hole of the communication passage 24 and is configured so that the opening amount of the communication passage 24 can be adjusted so as to be increased and decreased due to shift downward due to rotation of the finger grip 25a (a direction of loosing). Further, the finger grip 25a may be a vertical sliding system not limited to a screw rotation system and further, after the finger grip 25a is shifted for a predetermined amount for the holding tube 25c, the finger grip 25a may not be shifted or the finger grip 25a is prevented from falling off.

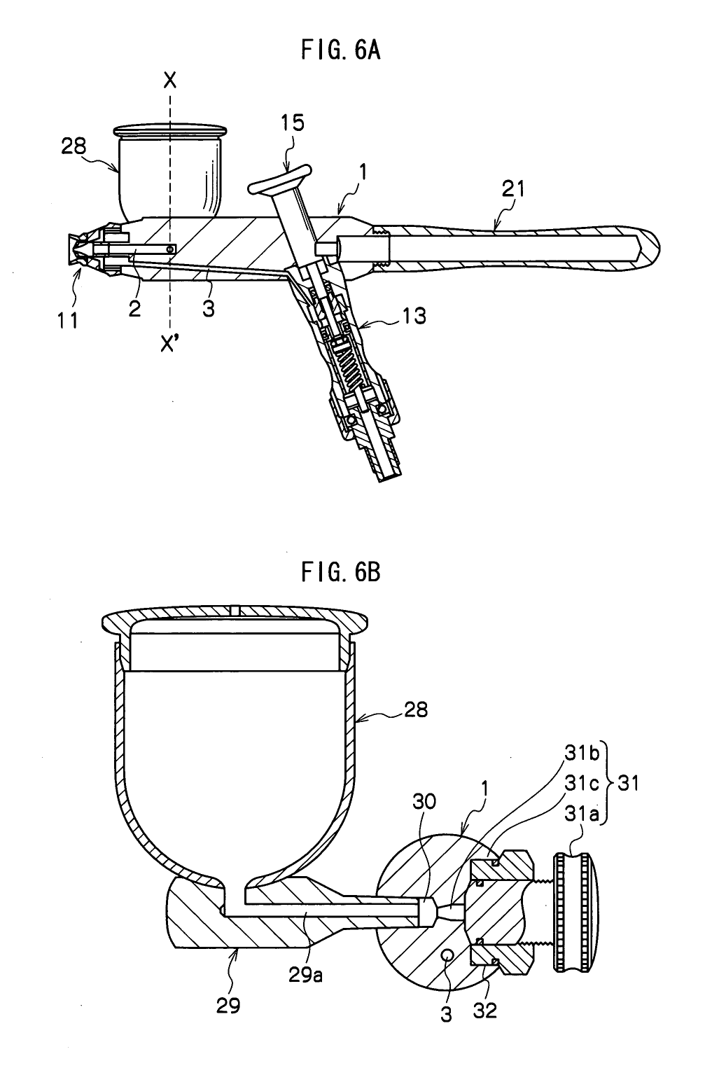

FIG. 6 shows an adjusting device 31 for adjusting a coating material discharge amount in a side cap type arranged on the side position (a left side or a right side) for the axis line of the nozzle. Further, a member as the same as the member shown in the above-described embodiment is given the same reference numerals and marks and the description thereof is herein omitted.

A coating material container 28 is firmly fixed to a connection member 29 on which a communication passage 29a is opened and the connection member 29 is configured so as to be capable of being connected to the coating material container 28 as being inserted in a insertion hole 30 formed in a taper shape that is opened on the side face of the main body of the air brush 1. The insertion hole 30 intersects the coating material passage 2 of the main body of the air brush 1, and thereby, the coating material contained in a coating material container 28 flows to the coating material passage 2 through a communication passage 29a and the insertion hole 30. Then, on the side face of the opposite side of the attachment face of the coating material container 28, an adjusting device 31 for adjusting the discharge amount of the coating material is attached.

The adjusting device 31 is configured by a finger grip 31a of a screw rotation system provided with a valve pestle 31b in a taper shape at its front end and a holding tube 31c for rotatably screwing and holding the finger grip 31a as same as the adjusting devices 5 and 25 according to the above-described embodiment. Then, the holding tube 31c is fitted and fixed on an attachment hole 32 that is opened on the main body of the air brush 1. Further, on the outer peripheral face of the front portion of the finger grip 31a and on the outer peripheral face of the holding tube 31c, a seal member 33 such as an O ring is mounted in order to secure airtightness with the corresponding holding tube and the corresponding main body of the air brush, respectively.

The valve pestle 31b is fitted to the front end portion of the insertion hole 30 at an intersect part between the coating material passage 2 and the insertion hole 30 and is configured so that the opening amount of the communication passage from the insertion hole 30 to the coating material passage 2 can be adjusted so as to be increased and decreased by back movement (a right direction in FIG. 6B) due to rotation of the finger grip 31a. Further, the finger grip 31a may be a sliding system not limited to a screw rotating system and further, after the finger grip 31a is shifted for a predetermined amount for the holding tube 31c, the finger grip 31a may not be shifted or the finger grip 31a is prevented from falling off.

In addition, the attachment position of the adjusting device 31 may be arranged in the middle of the coating material passage 2 to the nozzle 4 not limited to the intersect part between the coating material passage 2 and the insertion hole 30. In this case, the valve pestle 31b of the finger grip 31a blocks off the coating material passage 2 cutting across the coating material passage 2 and the opening amount of the coating material passage 2 can be adjusted so as to be increased and decreased due to back and forth movement of the valve pestle.

Further, in the side cap type shown in FIG. 6, the connection member 29 with the main body of the air brush 1 arranged on the coating material container 28 is provided on a bottom part of this container 28, however, the position of the connection member 29 may be provided on a middle position in a height direction of the coating material container 28. In this case, a communication passage 29a to be communicated with the inside of the coating material container 28 is formed along a peripheral wall of the container and a front end of the side of the container of the communication passage is opened on the bottom face. Thereby, even the side cap type can pull out the coating material due to suction.

The present invention is not limited to the illustrated embodiments but it can be modified without departing from the spirit thereof.
(1) The structure such that the coating material container 28 according to the embodiment of the above-described side cap type is connected to the main body of the air brush 1 may be a screw system using a hexagon cap nut not limited to the illustrated taper insertion system.
(2) The adjusting device for adjusting the discharge amount of the coating material may be a mechanism that can adjust the supply amount of the coating material from the coating material container to the nozzle not limited to the configuration to adjust the opening amount of a hole by pulling out the valve pestle from the hole.

Having described specific preferred embodiments of the invention with reference to the accompanying drawings, it will be appreciated that the present invention is not limited to those precise embodiments, and that various changes and modifications can be effected therein by one of ordinary skill in the art without departing from the scope of the invention as defined by the appended claims.

What is claimed is:

1. An air brush for deriving a coating material that is communicated and arranged on a passage to be communicated with a nozzle from the nozzle and atomizing and spraying the coating material by a compressed air at the outside of the nozzle by guiding the compressed air inducted into the main body of the air brush into the inside of the main body of the air brush and injecting the compressed air from a gap between the nozzle attached at a front end of the main body of the air brush and an air cap;
wherein an air bulb that is mounted in an air induction part provided on the main body of the air brush is opened by pushing of an operational button and an adjusting device for adjusting a discharge amount of the coating material is provided on a position deviated from an axis line of the nozzle in a passage of the coating material communicated with the nozzle.

2. The air brush according to claim 1,
wherein, in the air bulb mounted on the air induction part, an axial part above an O ring that adheres to a valve sheet is formed in a gentle taper shape, of which diameter is made smaller step by step as it is separated from the O ring and thereby, resistance is given to a flow of air to be inducted by pushing of the operational button.

3. The air brush according to claim 1,
wherein the adjusting device for adjusting the discharge amount of the coating material is a grip finger of a screw rotating system, a valve pestle formed in a taper shape is formed at a front end of the grip finger, and an opening of a passage is adjusted by back and forth movement of the valve pestle due to rotation of the finger grip.

4. The air brush according to claim 2,
wherein the adjusting device for adjusting the discharge amount of the coating material is a grip finger of a screw rotating system, a valve pestle formed in a taper shape is formed at a front end of the grip finger, and an opening of a passage is adjusted by back and forth movement of the valve pestle due to rotation of the finger grip.

5. The air brush according to claim 1,
wherein a figuration of supplying the coat material to a passage communicated with the nozzle is a suction system such that a coating material container is vertically arranged on a lower position from an axis line of the nozzle.

6. The air brush according to claim 2,
wherein a figuration of supplying the coat material to a passage communicated with the nozzle is a suction system such that a coating material container is vertically arranged on a lower position from an axis line of the nozzle.

7. The air brush according to claim 3,
wherein a figuration of supplying the coat material to a passage communicated with the nozzle is a suction system such that a coating material container is vertically arranged on a lower position from an axis line of the nozzle.

8. The air brush according to claim 1,
wherein a figuration of supplying the coat material to the passage communicated with the nozzle is a weight system such that the coating material container is arranged on an upper position from the axis line of the nozzle.

9. The air brush according to claim 2,
wherein a figuration of supplying the coat material to the passage communicated with the nozzle is a weight system such that the coating material container is arranged on an upper position from the axis line of the nozzle.

10. The air brush according to claim 3,
wherein a figuration of supplying the coat material to the passage communicated with the nozzle is a weight system such that the coating material container is arranged on an upper position from the axis line of the nozzle.

11. The air brush according to claim 1,
wherein a figuration of supplying the coat material to the passage communicated with the nozzle is a weight system such that the coating material container is arranged on an upper position from the axis line of the nozzle.

12. The air brush according to claim 2,
wherein a figuration of supplying the coat material to the passage communicated with the nozzle is a weight system such that the coating material container is arranged on an upper position from the axis line of the nozzle.

13. The air brush according to claim 3,
wherein a figuration of supplying the coat material to the passage communicated with the nozzle is a weight system such that the coating material container is arranged on an upper position from the axis line of the nozzle.
